(19) United States
(12) Patent Application Publication
(10) Pub. No.: US 2008/0141599 A1
(43) Pub. Date: Jun. 19, 2008

(54) DEPLOYMENT APPARATUS AND SYSTEM FOR FLEXIBLE PROTECTIVE COVERING

(75) Inventors: Omer Akdag, Palm City, FL (US); Michael Francis Ciferri, Port St. Lucie, FL (US); Thomas J. Ahlstrom, Stuart, FL (US); Hans Christian Langstrup Nielsen, Palm City, FL (US)

Correspondence Address: POWELL GOLDSTEIN LLP, 901 NEW YORK AVENUE, N.W., 3RD FLOOR, WASHINGTON, DC, 20001-4413, US

(73) Assignee: DONOVAN ADVANCED HURRICANE PROTECTION INC., Stuart, FL (US)

(21) Appl. No.: 11/611,453

(22) Filed: Dec. 15, 2006

(51) Int. Cl. E06B 3/26

(52) U.S. Cl. 52/202; 16/96 R

(57) ABSTRACT

An automated deployment system for a flexible protective cover is provided. A first drive mechanism is connected to a flexible protective cover, including a drive cable that is connected at one end to an end of the flexible protective cover and spooled around a drive cable reel at the other end. The flexible protective cover is spooled around a roller bar which is connected to a second drive mechanism. A motor causes the drive cable to pull the end of the flexible protective cover, unspool the drive cable from the drive cable reel, and unspool the flexible protective cover from the roller bar. The flexible protective cover is configured to be secured within a track. A sensor, a controller operative to respond to signals from the sensor, and a braking mechanism may also be provided. The automated deployment system may be operated by remote control.

### FIELD OF ART

Aspects of the invention described herein relate to an apparatus and system for deploying a flexible protective covering used to protect a structure from damage due to flying projectiles during a storm such as a hurricane or tornado or from some other source such as an explosion or blast.

### BACKGROUND

Tropical storms and hurricanes are the costliest natural disasters in terms of both loss of property and loss of life. Much of the damage occurs when missile-like airborne debris hits a structure and penetrates a glass window or other opening such as a door, garage door, or sky light, allowing wind and wind-driven rain to intrude into the structure. People living in hurricane-prone areas understand that it is important to cover such fragile openings of a building prior to the hurricane and that doing so greatly reduces the risk of property damage. In addition, in the wake of recent intense hurricane seasons, most property insurance companies are giving discounts for premiums for the properties with proper hurricane protection. Thus, there is an incentive for people to protect their structures from possible hurricane damage.

In recent years flexible hurricane shutters have been introduced to the market. These flexible hurricane shutters are typically fabricated from commercially available high-strength woven fabrics. Their flexibility and light weight give them great advantage over other forms of hurricane coverings such as plywood or other rigid structures in term of handling, installation, and storage. However, these flexible shutters can alter the exterior appearance of a building or can block or attenuate the sunlight in the interior, and therefore often are installed or utilized only just before a hurricane and are removed afterwards.

Deploying and storing hurricane shutters can be time-consuming, awkward, and difficult. For example, hurricane shutters are often employed in high-rise condominium complexes along the coastline of Florida. However, the peak of the hurricane season occurs in summer, a time when the occupancy rate and maintenance staffing of such buildings is often fairly low because many residents use such a condominium only as a winter home. Even in other locations with year-round populations, many coastal structures are only occupied part time, and the residents may not be in place at the time of a hurricane. To further complicate matters, there often is only a few days' notice of an impending hurricane. Thus, it is often necessary to deploy a large number of hurricane shutters in a very short time despite limited access to the structure and limited number of personnel available to do so. In particular, access to the exterior windows of a high-rise structure may be limited, and it may not be possible to deploy a conventional flexible hurricane shutter system requiring bolting the shutter to the structure, buckling the shutter into a frame, or sliding the shutter into a framework of rails. Consequently, such structures may not be adequately protected from possible damage from an impending storm.

Several prior art automated flexible hurricane shutter deployment systems are in existence. Some of these systems use a gravity drive to assist in the deployment of the shutter. In such systems, a dead weight is attached to a free end of the shutter, and the shutter is pulled down to a closed position as a result of the gravitational force acting on the weight. Gravity-driven systems, however, are subject to the problem of “wind binding” that can occur with a flexible hurricane shutter. Wind binding occurs when the air pressure due to wind creates enough force on the flexible hurricane shutter to overcome the force applied by the gravity drive, causing the shutter to deform and reduce the protection provided. Wind binding also can limit the length of the opening where a gravity-driven flexible hurricane shutter can be used, since the more area of the shutter that is exposed to the wind, the greater the risk of excessive deformation due to wind binding. Since ocean front buildings are exposed to 15-25 MPH wind daily with significantly stronger winds during a storm, a flexible hurricane shutter using a gravity-driven deployment system often is not a good choice.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Aspects of the embodiments described herein relate to the need for an apparatus and system for protecting structures such as homes or commercial buildings or other objects such as automobiles or the like from damage caused by flying debris during a hurricane, tornado, or other storm, and further to protect from damage due to rain, hail, or wind. An automatic deployment system for a flexible hurricane shutter is provided that uses “forced-deploy” and “forced-store” features to cover and uncover relatively large openings while minimizing associated problems of wind binding.

### BRIEF DESCRIPTION OF THE DRAWINGS

FIG. 1 depicts an exemplary installation of a gravity driven automatic flexible hurricane shutter known in the art.

FIG. 2 depicts an exemplary gravity driven automatic flexible hurricane shutter deployment system known in the art.

FIG. 3 presents a more detailed view of a tubular actuator of an exemplary gravity driven automatic flexible hurricane shutter deployment system known in the art.

FIG. 4 depicts an automated deployment system for a flexible hurricane shutter according to one or more aspects described herein.

FIGS. 5A and 5B depict detailed views of a track used in an automated deployment system for a flexible hurricane shutter according to one or more aspects described herein and components thereof.

FIG. 6 depicts an isometric view of the exterior of a control box for an automated deployment system for a flexible hurricane shutter according to one or more aspects described herein.

FIG. 7 depicts an isometric view of the interior of a control box for an automated deployment system for a flexible hurricane shutter according to one or more aspects described herein.

FIG. 8 depicts a cross-sectional view of a control box for an automated deployment system for a flexible hurricane shutter according to one or more aspects described herein.

FIG. 9A depicts an isometric view of a control box for an automated deployment system for a flexible hurricane shutter according to one or more aspects described herein.

FIG. 9B depicts a detailed view of a shaft engagement interface in a control box for an automated deployment system for a flexible hurricane shutter according to one or more aspects described herein.

FIG. 10 depicts a flow diagram regarding the control logic used in a control box for an automated deployment system for a flexible hurricane shutter according to one or more aspects described herein.

### DETAILED DESCRIPTION

The various aspects summarized previously can be embodied in various forms. The following description shows, by way of illustration, various combinations and configurations in which the aspects can be practiced. It is understood that the described aspects and/or embodiments are merely examples, and that other aspects and/or embodiments can be utilized and structural and functional modifications can be made, without departing from the scope of the present disclosure. In particular, it should be noted that although the aspects herein are described in the context of a automated deployment apparatus and system for a flexible shutter for use to protect a structure from storms such as a hurricane or tornado, they can also be used with only minor modifications to protect other objects that may be exposed to damage, such as outdoor furnishings, automobiles, or gardens. In addition, the automated deployment system for a flexible shutter can also be used to activate protective coverings to protect from an explosion or a blast. Also, it should be noted that an automated deployment apparatus and system in accordance with aspects described herein can easily be modified to be operated via remote control using components and methods well known in the art, and that such a remote-controlled deployment apparatus and system is within the scope of the present disclosure.

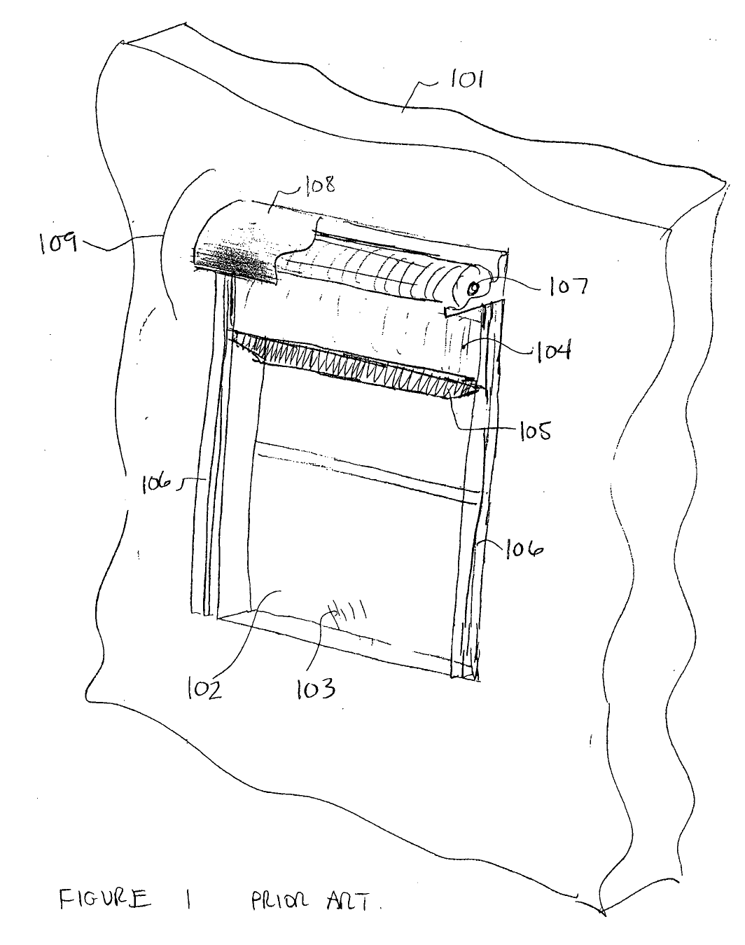

FIGS. 1-3 illustrate aspects of an automated deployment system for a flexible hurricane shutter known in the art. FIG. 1 depicts a typical gravity-driven automated flexible hurricane shutter deployment system application known in the art. As shown in FIG. 1, gravity-driven automated flexible hurricane shutter deployment apparatus 109 is placed over an opening 102 such as a glass window 103 in an exterior wall of a building 101. Two parallel tracks 106 are attached to the vertical sides of the opening to receive the deployed flexible hurricane shutter. The flexible hurricane shutter deployment apparatus 109 has housing 108 which contains a flexible hurricane shutter 104. As shown in FIG. 1, one end of the flexible hurricane shutter 104 is rolled around a tubular actuator 107, while the other end is affixed to a rigid weight 105. As the tubular actuator 107 unrolls the flexible hurricane shutter between tracks 106, rigid gravity bar 105 forces the flexible hurricane shutter 104 to move downward towards its deployed position. When use of the flexible hurricane shutter 104 is no longer needed, it is rolled onto the tubular actuator 107 and stored within housing 108.

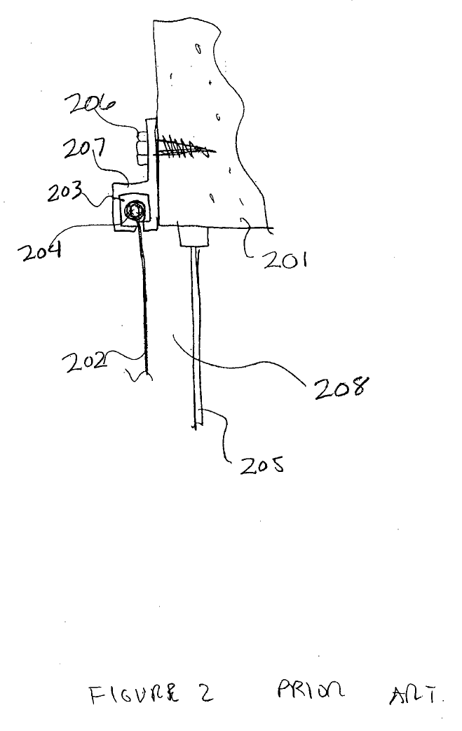

FIG. 2 illustrates a track 207 of a gravity-driven automatic flexible hurricane shutter deployment system known in the art. Track 207 is usually attached to the exterior of building 201 by mounting hardware 206. The flexible hurricane shutter 202 is furnished with a keder or sail spline 204 on its vertical edges, with keder 204 running in a square or rectangular groove 203 in track 207 so that flexible hurricane shutter 202 can be deployed to cover an opening 208 in a building 201 such as glass window 205.

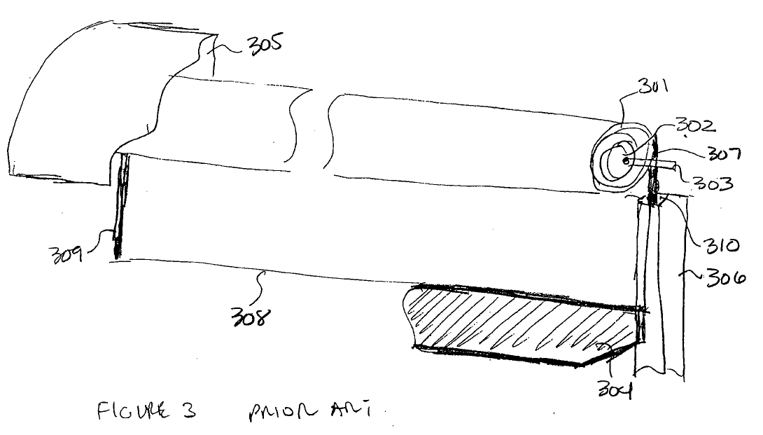

FIG. 3 illustrates a detailed view of a tubular activator 302 of a gravity-driven automatic flexible hurricane shutter system known in the art. Tubular actuator 302 is rotatably mounted on a shaft 303 which is attached to housing 305. As shown in FIG. 3, flexible hurricane shutter 301 is rolled over tubular actuator 302, and the free end 308 is attached to rigid gravity bar 304. As it is deployed, keder or sail spline 309 of flexible hurricane shutter 301 is fed through square or rectangular groove 310 and is placed between two parallel vertical tracks 306 which have been affixed to the structure as shown in FIG. 2.

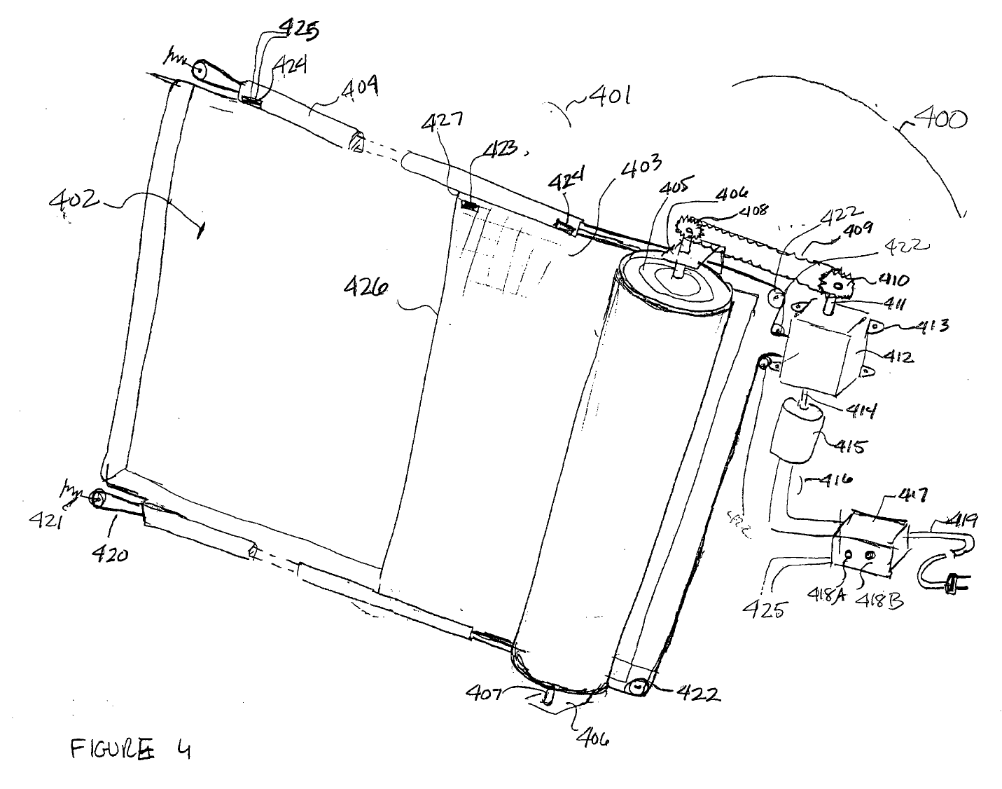

FIGS. 4-9 depict exemplary components of an automated deployment apparatus system for a flexible hurricane shutter according to one or more aspects herein. It is to be understood that the components and configuration of the apparatus and system shown in FIGS. 4-9 and described herein are exemplary only and should not be taken as limiting. One skilled in the art would readily understand that modifications can be made to the components and configurations shown and described herein without departing from the scope and spirit of the invention.

FIG. 4 provides an overview of an automated deployment apparatus and system for a flexible hurricane shutter according to one or more aspects described herein. According to one or more aspects shown in FIG. 4, automatic flexible hurricane shutter deployment apparatus 400 can be installed on building 401 having an opening 402 such as a window or door. According to one or more aspects, deployment system 400 can include a flexible hurricane shutter 403, tracks 404 to guide the flexible hurricane shutter 403 as it its deployed (closed) and stored (opened), and roller shaft 407 rotatably installed on bearing plates 406. Deployment system 400 also can include a drive system including drive cable 420 and tensional pulley 421, guide pulley 422, and belt pulleys 406 and 410; a power system including a shifter (not shown) in shifter control box 412, reversible drive motor 415; and signal control box 417 having deploy/store control switches 418A and 418B, respectively, proximity sensors 423 and 424, and power cord 419. According to one or more aspects, a flexible hurricane shutter 403 can be slideably installed between tracks 404 and attached to roller shaft 407 at one end and drive cable 420 at an opposite end. Flexible hurricane shutter 403 can be deployed by pulling on drive cable 420, which can be attached to the corners 427 of the free end 426 of the flexible hurricane shutter 403 and is fed back to a reel (not shown) in shifter control box 412 through grooves (not shown) in tracks 404 by means of tensional pulleys 421 and guide pulleys 422. According to aspects shown in FIG. 4, flexible hurricane shutter 403 can be stored by rolling it on roller bar 407, which is driven by a shifter (not shown) in shifter control box 412 via drive shaft 411, drive sprocket 410, chain drive 409, and slave sprocket 408. Proximity sensors 423 and 424 can prevent flexible hurricane shutter 403 from passing beyond a totally deployed or stored position by sending a signal through conductors 425 to signal control box 417 to stop further movement of the shutter. Automated deployment system 440 can be driven, both in its deployment and storage operations, by reversible drive motor 415 attached to signal control box 417 by wires 416, which can be directed by signal control box 417 having deploy/store control switches 418A and 418B and a power cord 419 for use with a household electric receptacle.

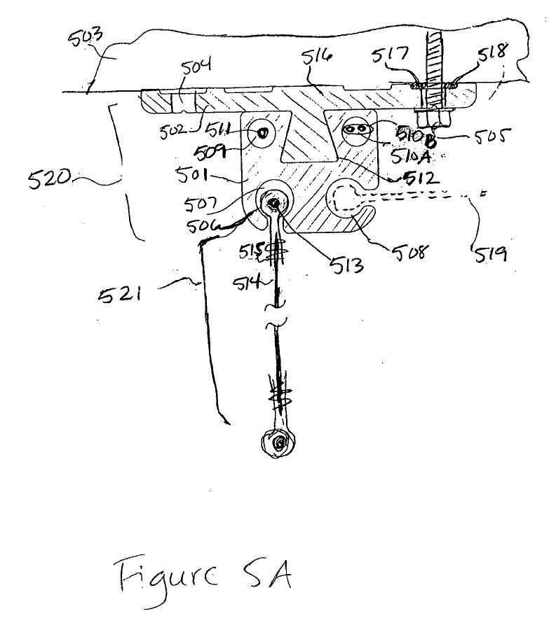

FIGS. 5A and 5B depict a detailed cross-sectional view and an isometric view, respectively, of an exemplary track 520 and related components that can be used to guide and support a flexible hurricane shutter according to one or more aspects described herein. As shown in FIG. 5A, flexible hurricane shutter 521 is slideably mounted onto guide track 501. Flexible hurricane shutter 521 can be made of any material used for providing flexible protection, and according to one or more aspects, can be made of a high strength flexible membrane 514 with a keder 506 stitched thereon. Keder 506 can have a steel cable 513 embedded in its core to provide additional strength and support for the shutter 521. Shutter 521 can be slideably mounted onto guide track 501, and the shape of the groove 507 and keder 506 can maintain the shutter 521 between the guide tracks during deployment and storage.

Because the deployment system according to aspects herein uses drive cables rather than gravity to close and open the shutter, a flexible hurricane shutter using a track system in accordance with one or more aspects described herein can be installed and configured to protect a variety of openings. For example, flexible hurricane shutter 521 can also be installed parallel 519 to base track 502 using groove 508 to effect a horizontal configuration whereby the flexible hurricane shutter is pulled across the opening, for example, from left to right, rather than from the top to the bottom. Such a horizontal configuration may be very useful to protect sliding glass doors or other wide openings. In either a vertical or horizontal installation, groove 507 and keder 506 can maintain the shutter 521 between the guide tracks, and thus in a properly deployed position, when shutter 521 is subjected to wind and/or impact forces, thus permitting shutter 521 to more fully protect the openings over which it is deployed.

Guide track 501 can also be furnished with holes 509 used to route the proximity sensor signal cable 510A and returning drive cable 510B. Guide track 501 and track base 502 can engage to each other through, for example, a dovetail-shaped tongue and groove pair 512. The track base can also be shaped to provide an increased cross-section 516 to provide support to the dovetail-shaped engagement areas 512. The track base further can have surface grooves (not shown) to accommodate surface irregularities of the wall, floor, or ceiling of a building and provide room to apply sealant 517, which can be used to prevent water entry into holes in the building created by, for example, installation hardware 505. In one exemplary configuration such as that shown in FIG. 5B, track base 502 can be approximately 2″ wide and can be installed every ½ to 3 feet, depending on the calculated wind load, to support guide track 510 and to provide stability and security for the hurricane shutter and enhance its ability to protect the structure from damage.

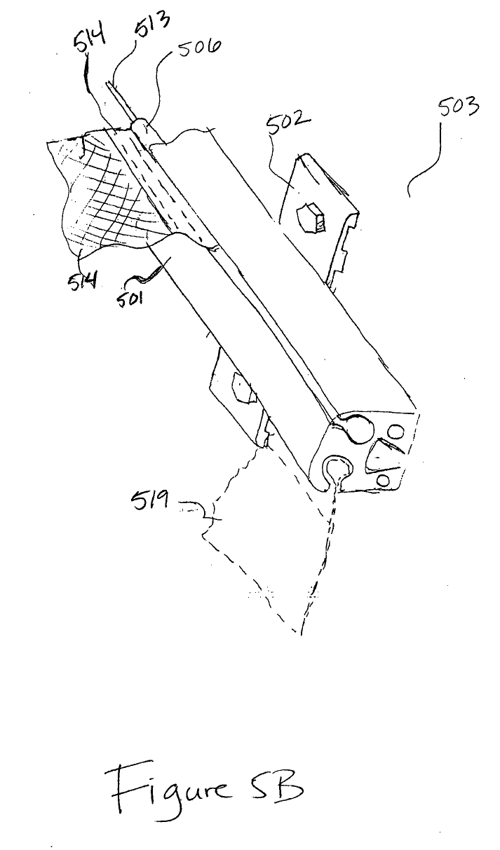

FIG. 6 presents an illustrative isometric exterior view of a shifter control box 412 shown in FIG. 4 for an automated flexible hurricane shutter system according to one or more aspects described herein. According to aspects depicted in FIG. 6, external components of shifter control box 412 can include housing 601, one or more shifter actuators 605, a shifter actuator bracket 612, a shifter lever 607, a shifter return spring 613, a shifter actuator link 606, a drive chain shaft 608, a drive chain spur gear 609, a gear motor 602, a motor bracket 603, a motor shaft coupling 604, and drive cables 420 fed through opening 610.

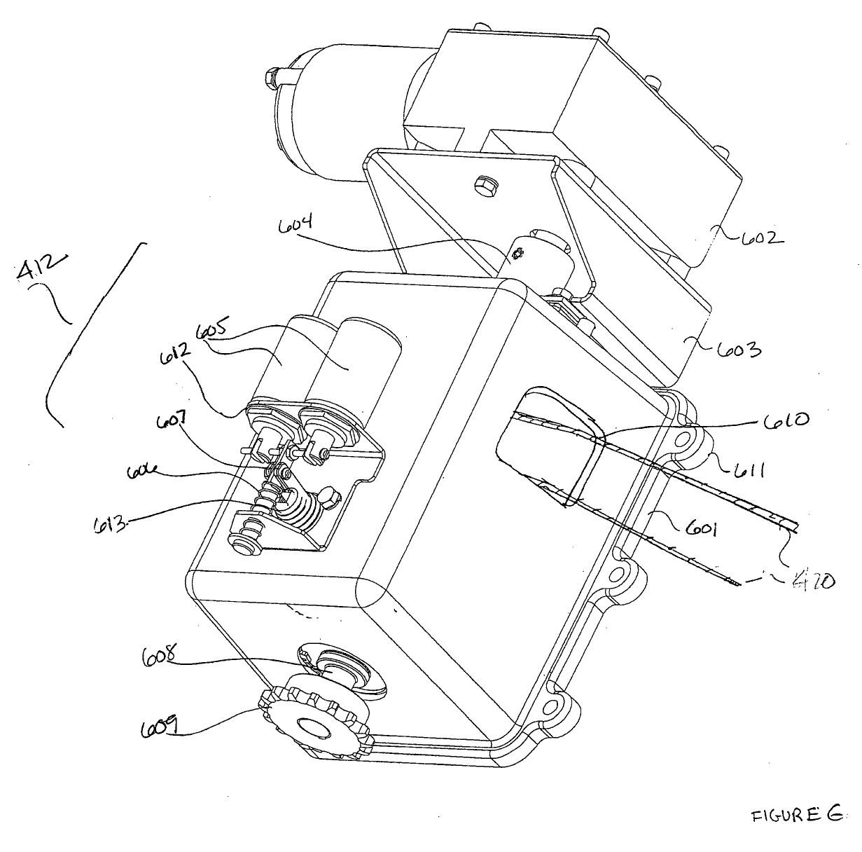

FIG. 7 presents an illustrative isometric interior view of a shifter control box 412 for an automatic flexible hurricane shutter system according to one or more aspects described herein. According to aspects depicted in FIG. 7, internal components of shifter control box 412 can include a drive cable reel 701, a shifter lever 607, a shifter 702, a drive chain shaft 608, a shaft engagement interface head 705 of a drive chain shaft 608, a control box drive shaft 703, a drive cable reel shaft 704, a shutter cover 709 (partially shown), a brake compression plate 706 for drive cable wheel 701, one or more springs for a brake 707, a brake liner 708, and installation hardware 710 for a brake pressure plate 706.

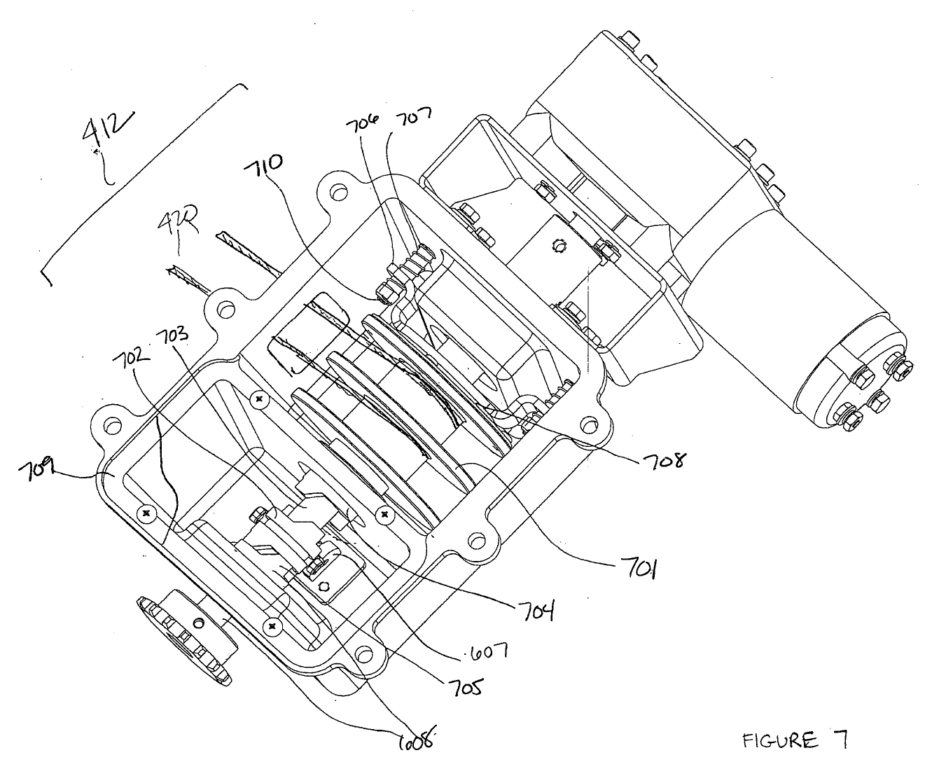

FIG. 8 depicts a cross-sectional view of an illustrative shifter control box 412 for an automated flexible hurricane shutter system according to one or more aspects described herein. According to aspects depicted in FIG. 8, a control box drive shaft 703 can be rotatably installed on roller bearing 806 and low profile cylindrical bearing 801, which can be coated with a PTFE coating. According to one or more aspects shown in FIG. 8, a control box drive shaft 703 can be supported by bearings 801 and 806, drive cable reel shaft 704 can be supported by bearings 805 and 807, and a drive chain shaft 608 can be supported by bearings 801 and 802. Control box drive shaft 703 also can have shifter 702 slideably installed onto it. According to one or more aspects, an attachment between shifter 702 and control box drive shaft 703 can be in, for example, a keyed or a splined engagement, and depending on a geometric configuration of the attachment, shifter 702 can either turn with control box drive shaft 703 or slide back and forth along control box drive shaft 703. A shifter lever 607 can be pivotally attached to housing 601 by an attachment which can have a pivot point 808 at approximately the mid-point of shifter lever 607. A shifter lever 607 can be pivotally attached at one end to an actuator link 606, and at the other end can be in contact with grooves 803 of shifter 702 via pins (not shown). According to one or more aspects, shifter actuator 605 can move actuator linkage 606, for example, in a back and forth manner 809. When shifter actuator 605 is energized, actuator linkage 606 can be pulled towards shifter actuator 605 to cause shifter lever 607 to move and in turn cause shifter 702 to move slideably along control box drive shaft 703 to engage with cable reel drive shaft 704. When shifter actuator 605 is not energized, shifter return spring 613 can cause shifter actuator linkage 606 to be pulled away from shifter actuator 605 to cause shifter lever 607 to move and in turn cause shifter 702 to move slideably along control box drive shaft to engage with chain drive shaft 608. According to one or more aspects, shifter 702 can engage with any one of control box drive shaft 703, drive cable reel shaft 704, and chain drive shaft 608. When shifter 702 is engaged, power from the motor is transferred to the element (i.e., one of control box drive shaft 703, drive cable reel shaft 704, and chain drive shaft 608) with which shifter 702 is engaged, and each of the other two elements can rotate around its axis independently of the other elements. The rotational motion of drive cable reel 701 can be damped by a braking system which can include brake pad 810 and brake pressure plate 706 to prevent uncontrolled motion of a drive cable 420 in uncoiling from a drive cable reel 701.

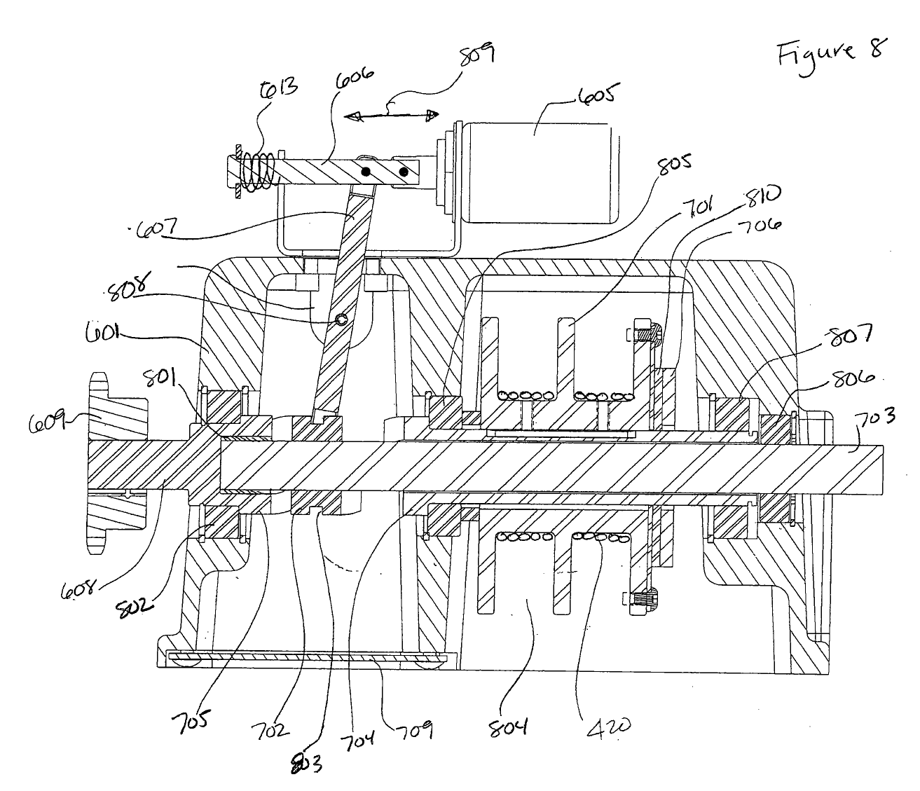

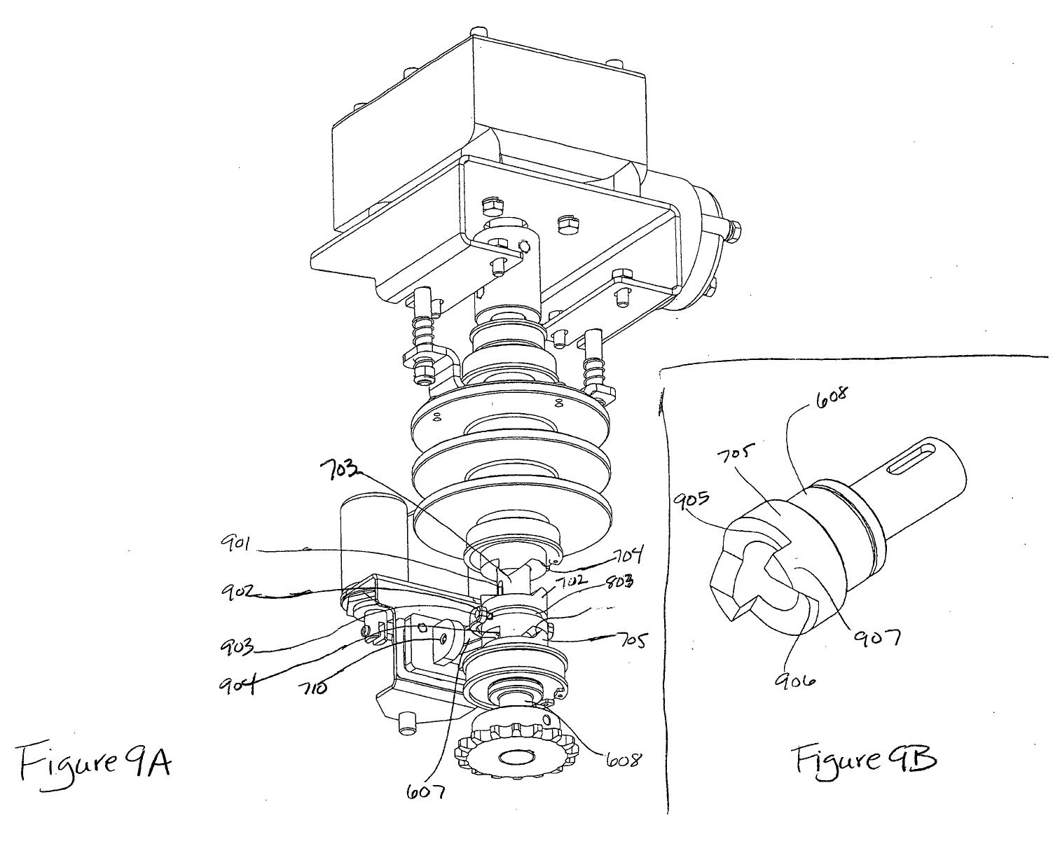

FIG. 9A provides an exemplary isometric view of the interior of a drive control box for an automated flexible hurricane deployment system according to one or more aspects described herein. FIG. 9B depicts an exemplary detailed view of a shaft engagement interface in accordance with one or more aspects. In the exemplary aspects shown in FIGS. 9A and 9B, shifter 702 can be slideably installed on the control box drive shaft 703 on a key and keyway 901 to transfer motion from the control box drive shaft 703. Shifter lever 607 can have a crescent-shaped end 902 having guide pins 903 on opposite ends of the crescent-shaped end 902 and can ride in groove 803 of shifter 702 to move shifter 702 axially on control box drive shaft 703. According to aspects shown in FIG. 9B, shifter 702 and chain drive shaft 608 and drive cable reel shaft 704 can all have similar shaft engagement interfaces. Shaft engagement interface 705 can have two or more protruding fingers 907, with one edge 905 perpendicular to the axis of shaft 704 and one edge 906 angled with respect to the axis of shaft 704. One or both of drive cable reel shaft 704 and drive chain shaft 608 can have a shaft engagement shape that is a mirror image of the shaft engagement interface of shifter 702, i.e., a perpendicular edge 905 can come into contact with a perpendicular edge of a shaft engagement interface 705 of shifter 702, which can rotate in one direction to drive the shaft, and an angled edge 906 can come in contact with an angled edge of a shaft engagement interface of shifter 702 and can rotate in the opposite direction to force a disengagement from interface 705.

An exemplary manner of operation of an automated deployment system for a flexible hurricane shutter system in accordance with one or more aspects will now be described. In the description below, the term “open” is used to refer to the flexible hurricane shutter when it is in its stored position, and “closed” is used to refer to the flexible hurricane shutter when it is in its deployed position. It is to be noted that the operation described below is in the context of the elements shown in the Figures herein, and that other elements or configurations can also be used within the scope and spirit of one or more described aspects.

In accordance with one or more aspects, deploy control switch 418A on signal control box 417 can be activated to close the flexible hurricane shutter so that it can protect the desired opening or other structure. In accordance with one or more aspects, the deployment system for a flexible hurricane shutter can be configured so that in the event of a failure of shifter actuator 405, the default position of the flexible hurricane shutter is a “closed” position. When deploy control switch 418A is activated on signal control box 417 while flexible hurricane shutter 403 is in its stored position, reversible drive motor 415 is activated to rotate counterclockwise, and the motion of the motor is transmitted to control box drive shaft 703 which in turn can rotate in a counter-clockwise direction. The counterclockwise rotation of control box drive shaft 703 in turn causes shifter 702 to also rotate in a counterclockwise direction. When control box drive shaft 703 and shifter 702 are rotated in a counterclockwise direction, engagement interface 705 with the aid of shifter return spring 613 and pivot-mounted 710 shifter lever 607 causes shifter 702 to slide towards cable drive reel shaft 704 so that shifter lever 607 can engage shifter 702. At this point, motion is transferred from reversible drive motor 415 to drive cable reel 701, which spools drive cable 420 onto it, and chain drive shaft 608 can spin freely on its axis. Drive cable reel 701 has two compartments 704 to accommodate drive cables 420 attached to one or more corners 417 of flexible hurricane shutter 403. As is seen in FIGS. 4 and 5A, drive cable 420 can be guided through cable pulleys 422, track hole 510A, tensional pulley 421, and track groove 507 to one or more corners 427 of flexible hurricane shutter 403. Drive cable 420 is then spooled onto reel 701, and as it does so, flexible hurricane shutter 403 will be pulled towards its deployed (closed) position. Since chain drive shaft 411 rotates freely, roller bar 407 for flexible hurricane shutter 403, which is connected to chain drive shaft 411 by means of drive chain 409, master 410 and slave 408 chain sprockets, will un-spool the flexible hurricane shutter 403 from the roller bar 407. This motion will continue until stopped, for example by a stop signal generated by proximity sensors 423 when hurricane shutter 403 reaches its fully deployed position. At that time, proximity sensors 423 send a signal to control box 417 by means of signal cables 424 that the hurricane shutter is fully deployed and the deploy control switch 418A is deactivated to stop any further deployment of the shutter. Alternatively, the deploy control switch 418A can be manually deactivated to stop any further deployment once the shutter reaches the desired position.

In accordance with one or more aspects, an automated flexible hurricane shutter can also be opened from its deployed (closed) position and stored, for example, in a housing (not shown). To store (open) the flexible hurricane shutter, store control switch 418B is activated on signal control box 417 when flexible hurricane shutter 403 is in its deployed position. When store control switch 418B is activated, reversible drive motor 415 and shifter actuator 405 (preferably in the form of a pull-type solenoid) are activated to rotate in a clockwise direction, and this motion is transmitted to control box drive shaft 703 which in turn can rotate in a clockwise direction. The clockwise rotation of control box drive shaft 703 in turn causes shifter 702 to also rotate in a clockwise direction. When control box drive shaft 703 and shifter 702 are rotated in a clockwise direction, engagement interface 705 with the aid of shifter actuator 605 though pivot-mounted 710 shifter lever 607 can force shifter 702 to slide towards chain drive shaft 608 to engage shifter 702. At this point, motion is transferred from reversible drive motor 415 to chain drive shaft 608, which drives roller bar 407 through master 410 and slave 408 chain sprockets and drive chain 409, and drive cable reel shaft 704 can spin on its axis independently from control box drive shaft 703. At this point, flexible hurricane shutter 403 is spooled on roller bar 407 and drive cable 417 continues to unspool from drive cable reel 701. Brake liner 708, brake pressure plate 706 and brake springs 707 prevent uncontrolled unspooling of drive cable 427 from reel 701. The spooling motion of the flexible hurricane shutter 403 will continue until stopped, for example, by a stop signal generated by proximity sensors 423 when flexible hurricane shutter 403 reaches its fully stored position. At that time, proximity sensors 423 send a signal to signal control box 457 through signal cables 424 that the hurricane shutter is fully spooled onto roller bar 407, and store control switch 418B is deactivated to stop any further spooling of the shutter. Alternatively store control switch 418B can be manually deactivated to stop any further opening the shutter when flexible hurricane shutter 403 reaches the desired position.

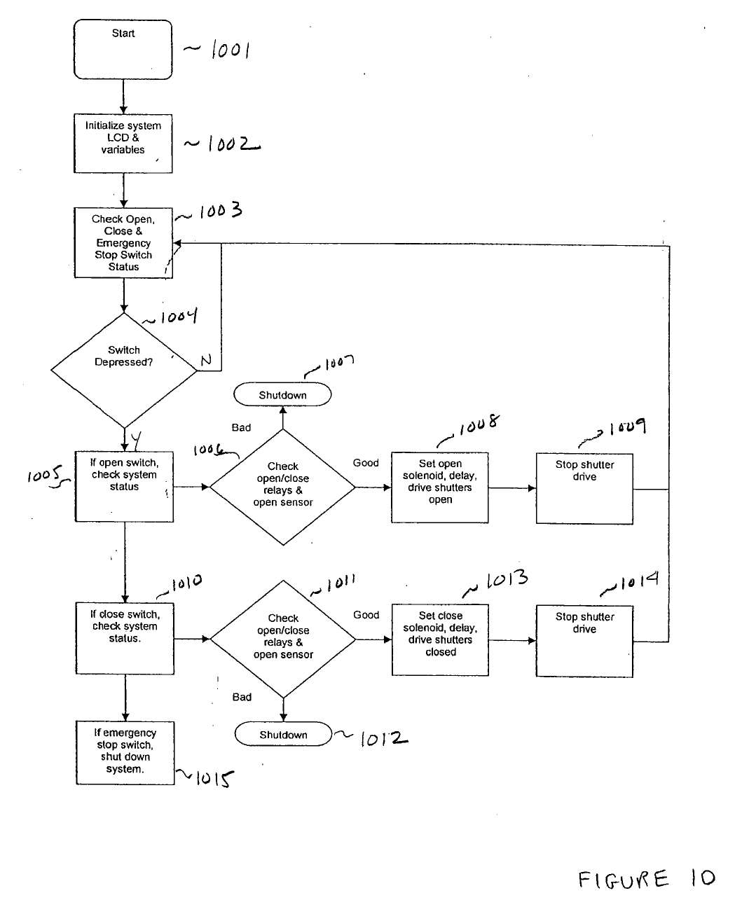

FIG. 10 presents a logic sequence that can be used by a controller in operation of a deployment mechanism for an automated flexible hurricane shutter in accordance with one or more aspects. In accordance with the logic sequence shown in FIG. 10, the operation begins at step 1001 to start the sequence. At step 1002, a controller can initialize system LCD and variables used in operating the deployment mechanism. At step 1003, the system checks the status of open, close, and emergency stop switches in the mechanism, for example, to determine whether any of the switches are depressed. At step 1004, the system determines whether a switch is depressed. If is switch is not depressed, the system returns to step 1003 to check the status of the switches again. If a switch is depressed, the system determines which type of switch, i.e., “open,” “close,” or “emergency stop” switch. If the depressed switch is a “close” switch, at step 1010 the controller checks the system status and at step 1011 checks the open/close relays and the open sensor. If the result of the check is a “bad” status, at step 1012 the system shuts down and takes no further action. If the result of the check is a “good” status, at step 1013 the system sets the solenoid to a “closed” status and sets the shutter drive to “close” to deploy the shutter. When the shutter is fully deployed, at step 1014 the system stops the shutter drive and returns to step 1003 to check the status of the open, close, and emergency stop switches. If the depressed switch is an “emergency stop” switch, at step 1015 the controller shuts down the system and takes no further action. If the depressed switch is an “open” switch, at step 1005 the controller checks the system status and at step 1006 checks the open/close relays and the open sensor. If the result of the check is a “bad” status, at step 1007 the system shuts down and takes no further action. If the result of the check is a “good” status, at step 1008 the system sets the solenoid to an “open” status and sets the shutter drive to “open” to return the shutter to its stored position. When the shutter is fully stored, at step 1009 the system stops the shutter drive and returns to step 1003 to check the status of the open, close, and emergency stop switches.

Although the present invention has been described in terms of preferred and exemplary embodiments thereof, numerous other embodiments, modifications and variations within the scope and spirit of the appended claims will occur to persons of ordinary skill in the art from a review of this disclosure.

What is claimed is:

1. An automated deployment system for a flexible protective cover, including:
a flexible protective cover, the flexible protective cover having a first end and a second end opposite the first end, the first end being a free end and the second end being attached to a roller bar, the flexible protective cover further being spooled around the roller bar from the attached end;
a motor;
a first drive means, the first drive means including a drive cable having a first end and a second end, the first end being attached to the free end of the flexible protective cover and the second end being attached to a drive cable reel, at least a portion of the drive cable between the first and second ends being spooled around the drive cable reel;
a shifter operatively connected to the motor, the shifter being capable of selectively shifting power supplied by the motor to the drive cable reel to cause the drive cable to unspool from the drive cable reel;
wherein the first end of the drive cable pulls the free end of the flexible protective cover to unspool the flexible protective cover from the roller bar.

2. The automated deployment system for a flexible protective cover according to claim 1, further comprising a track, wherein an edge of the flexible protective cover is adapted to be secured within the track, and further wherein the edge of the flexible protective cover is maintained within the track as it is unspooled from the roller bar.

3. The automated deployment system for a flexible protective cover according to claim 2, wherein the track is configured to accommodate one of a horizontal and a vertical installation.

4. The automated deployment system for a flexible protective cover according to claim 1, wherein the motor is remotely controlled.

5. The automated deployment system for a flexible protective cover according to claim 1, wherein the motor is manually controlled.

6. The automated deployment system for a flexible protective cover according to claim 1, wherein the motor is electrically powered.

7. The automated deployment system for a flexible protective cover according to claim 1, wherein the motor is hydraulically powered.

8. The automated deployment system for a flexible protective cover according to claim 1, wherein the motor is powered by a fossil fuel.

9. The automated deployment system for a flexible protective cover according to claim 1, further comprising a sensor disposed near the first end of the flexible protective cover, the sensor being configured to send a signal based on a position of the flexible protective cover, and a controller being configured to receive and process the signal, wherein the controller controls the operation of the motor in response to the signal.

10. The automated deployment system for a flexible protective cover according to claim 1, further comprising a brake operatively connected to the controller and to the drive cable reel, the brake being capable of controlling a rate at which the drive cable unspools from the cable reel.

11. The automated deployment system for a flexible protective cover according to claim 1, further including:
a second drive means, the second drive means comprising:
a drive shaft operatively connected to the motor;
a first sprocket, the first sprocket being operatively connected to the drive shaft;
a second sprocket, the second sprocket being operatively connected to the roller bar; and
a second drive cable, the second drive cable extending between the first and second sprockets;
wherein the second sprocket rotates in response to a motion of the second drive means; and
wherein the roller bar rotates in response to the rotation of the second sprocket to further unspool the flexible protective cover.

12. The automated deployment system for a flexible protective cover according to claim 11, wherein the second drive means is one of a chain drive, a belt drive, and a gear drive.

13. A control system for automated deployment of a flexible protective cover, including:
a drive motor;
a drive shaft coupled to the drive motor;
a shifter, the shifter being slideably mounted on the drive shaft;
a first drive means, the first drive means including a drive cable reel having an end of a drive cable attached thereto and at least a portion of the drive cable spooled thereon;
a second drive means, the second drive means including:
a first sprocket, the first sprocket being operatively connected to the drive shaft;
a second sprocket, the second sprocket being operatively connected to a roller bar, the roller bar having a flexible protective cover spooled thereon; and
a second drive cable, the second drive cable extending between the first and second sprockets;
wherein the shifter is capable of selectively shifting power supplied by the motor to the drive cable reel to cause the drive cable to unspool from the drive cable reel; and the second drive means causing the roller bar to rotate.

14. The control system for automated deployment of a flexible protective cover according to claim 13, wherein the drive motor is remotely controlled.

15. The control system for automated deployment of a flexible protective cover according to claim 13, wherein the drive motor is manually controlled.

16. The control system for automated deployment of a flexible protective cover according to claim 13, wherein the drive motor is electrically powered.

17. The control system for automated deployment of a flexible protective cover according to claim 13, wherein the drive motor is hydraulically powered.

18. The control system for automated deployment of a flexible protective cover according to claim 13, wherein the drive motor is powered by a fossil fuel.

19. The control system for automated deployment of a flexible protective cover according to claim 13, wherein the second drive means is one of a chain drive, a belt drive, and a gear drive.

20. The control system for automated deployment of a flexible protective cover according to claim 13, further comprising a sensor, the sensor being configured to send a signal based on a position of a flexible protective cover, and a controller being configured to receive and process the signal, wherein the controller controls the operation of the drive motor in response to the signal.

21. The control system for automated deployment of a flexible protective cover according to claim 13, further comprising a brake operatively connected to the controller and to the drive cable reel, the brake being capable of controlling a rate at which the drive cable unspools from the cable reel.

22. The control system for automated deployment of a flexible protective cover according to claim 13, further comprising a shifter actuator operably coupled to the shifter, the shifter actuator being capable of controlling the movement of the shifter

23. The control system for automated deployment of a flexible protective cover according to claim 22, wherein the shifter actuator is electrically powered.

24. The control system for automated deployment of a flexible protective cover according to claim 22, wherein the shifter actuator is hydraulically powered.

25. The control system for automated deployment of a flexible protective cover according to claim 22, wherein the shifter actuator is powered by pressurized gas.

26. The control system for automated deployment of a flexible protective cover according to claim 13, further comprising a shaft engagement interface, the shaft engagement interface including:
a substantially cylindrical base coupled to a shaft, the base having an upper and a lower surface, the upper surface being substantially perpendicular to a longitudinal axis of the shaft, a plurality of protrusions extending from the upper surface of the base, each of the protrusions having a first edge and a second edge, the first edge being substantially perpendicular to upper surface of the base and the second edge being angled with respect to the upper surface of the base;
the protrusions being further configured to engage with a shifter having a shape substantially conforming to the shape of the plurality of the protrusions;
wherein the plurality of protrusions engage with the shifter to form a coupled interface operably connected to the shaft, and further wherein a rotation of the coupled interface in a first direction causes the shaft to rotate around the longitudinal axis of the shaft, and a rotation of the coupled interface in a second direction causes the coupled interface become uncoupled.

27. A track system for a flexible protective cover, including:
a track base capable of being mounted to a structure and having a protrusion extending therefrom;
a guide track, the guide track including an indentation on a first side, the indentation conforming to the shape of the protrusion on the track base; the guide track further including a first groove on a second side, the first groove capable of receiving a first edge of the flexible protective cover; and the guide track further including a first opening extending therethrough, the opening being capable of receiving a first cable associated with the flexible protective cover;
wherein the indentation in the guide track engages with the protrusion in the track base to secure the guide track to the track base.

28. The track system of claim 27, wherein the protrusion and indentation engage in a dove-tailed configuration.

29. The track system of claim 27, wherein the track base further includes a plurality of surface grooves on a side opposite the protrusion.

30. The track system of claim 27, the guide track further including a second groove capable of receiving a second edge of the flexible protective cover, the guide track being capable of guiding the flexible hurricane shutter in one of a horizontal or a vertical direction.

31. The track system of claim 27, wherein the track base includes a groove capable of accepting a sealant disposed between the track base and the structure.

32. The track system of claim 27, wherein the guide track further includes a second opening extending therethrough, the second opening being capable of accepting a second cable associated with the flexible protective cover.

33. The track system of claim 27, wherein the track base is configured to be mounted to the structure in sections.

34. The track system of claim 27, wherein the track base is capable of being mounted on the building by any one of fastening, bonding, welding, and fusing.
